(19) United States
(12) Patent Application Publication
(10) Pub. No.: US 2025/0365056 A1
(43) Pub. Date: Nov. 27, 2025

(54) BEAM ALIGNMENT IN COMMUNICATION SYSTEM

(71) Applicant: HUAWEI TECHNOLOGIES CO., LTD., Shenzhen (CN)

(72) Inventors: Thorsten Schier, Lund (SE); Salah Eddine Hajri, Lund (SE); Lifu Liu, Shanghai (CN)

(73) Assignee: HUAWEI TECHNOLOGIES CO., LTD., Shenzhen (CN)

(21) Appl. No.: 19/294,671

(22) Filed: Aug. 8, 2025

Related U.S. Application Data
(63) Continuation of application No. PCT/CN2023/075104, filed on Feb. 9, 2023.

(51) Int. Cl. H04B 7/06; H04L 5/00

(52) U.S. Cl. CPC H04B 7/06952; H04L 5/0044

(57) ABSTRACT

Embodiments of the application relate to beam alignment in a communication system (500), the beam alignment using artificial intelligence and/or machine learning for downlink transmit beam predictions during operation. A client device (100) determines, as part of a beam alignment procedure, a set of candidate transmit beams of a network access node (300). This determination is based on a set of measured reference signals transmitted in a set of transmit beams of the network access node (300). In addition, the client device (100) also determines a beam measurement information of the client device (100) to be used for subsequent reference signal transmissions based on the set of candidate transmit beams. The client device (100) transmits the beam measurement information to the network access node (300), which is used by the network access node (300) in the subsequent reference signal transmissions.

### CROSS-REFERENCE TO RELATED APPLICATIONS

This application is a continuation of International Application No. PCT/CN2023/075104, filed on Feb. 9, 2023, the disclosure of which is hereby incorporated by reference in its entirety.

### TECHNICAL FIELD

Embodiments of the application relate to beam alignment for a client device and a network access node in a communication system. Furthermore, embodiments of the application also relate to corresponding methods and a computer program.

### BACKGROUND

In the 3^{rd} generation partnership project (3GPP), beam management procedures have been specified, as it is a critical feature in high frequency ranges, for example within 5G new radio (NR) frequency range 2 (FR2).

A client device, such as a user equipment (UE), and a network access node, such as a next generation base station (gNB) or a transmission reception point (TRP), may use transmission (Tx) beams for transmitting information over an air interface and/or may use reception (Rx) beams for receiving information over the air interface, in the downlink (DL) and/or uplink (UL) directions. Therefore, suitable Tx beams and/or Rx beams should be selected for such transmissions and receptions, respectively.

There are a number of factors related to the spatial and time domain features of the beams that should be taken into consideration when selecting suitable Tx beams and/or Rx beams to be used. For example, in high frequency ranges, the beams are typically narrow in order to guarantee sufficient coverage, which results in a large number of potential beams to be evaluated, in order to select the most suitable beams for the current spatial channel characteristics. Also, due to the mobility of the UE, the beams being suitable for usage, i.e. the beams providing the best equivalent channel conditions for communication, may vary over time, where a variation rate for suitability of the beams may depend e.g. on the beam design, such as the beam width, and/or on a mobility pattern and a velocity of the UE. Typically, the periodicity for determination of suitable beams depends on the velocity of the UE and its direction of movement with respect to a gNB or a TRP.

The beam management, i.e. the selection of suitable Tx beams and/or Rx beams, is thus a complex procedure, including spatial and time domain beam predictions in order to be efficient. Therefore, it has been suggested that artificial intelligence and/or machine learning (AI/ML) should be used for air interface beam management, to take advantage of their ability to understand patterns and dependencies in data, which are not typically captured by conventional signal processing techniques.

### SUMMARY

An objective of embodiments of the application is to provide a solution which mitigates or solves the drawbacks and problems of conventional solutions.

Another objective of embodiments of the application is to provide a solution which improves beam management, more specifically beam alignment, between a client device and one or more network access nodes.

The above and further objectives are solved by the subject matter of the independent claims. Further embodiments of the application can be found in the dependent claims.

According to a first aspect of the application, the above mentioned and other objectives are achieved with a client device for a communication system, the client device being configured to:
determine a set of candidate transmit beams of a network access node based on a set of measured reference signals transmitted in a set of transmit beams of the network access node in a beam alignment procedure;
determine a beam measurement information of the client device for subsequent reference signal transmissions based on the set of candidate transmit beams; and
transmit the beam measurement information to the network access node.

Subsequent reference signal transmissions may be understood as reference signal transmissions used for beam management within a given time interval from the transmission or reception of the beam measurement information.

An advantage of the client device according to the first aspect is that the following initial measurements on downlink reference signals in the determined set of candidate transmit beams, i.e. the measurements where the client device determines possible suitable Rx beams for each of the transmit beams and conveys this information to the network, can be made more efficient based on the beam measurement information the client device has previously derived and conveyed to the network access node. Thus, the client device conveys to the network access node information about the measurement behavior the client device will adopt to during the subsequent beam pair measurements/sweeping. Since the goal is to select suitable beam pairs, i.e. Tx and Rx beams for downlink and/or uplink, the number of possible beam pairs can be considerable, especially for multi-panel and high capability client devices. Beam measurement information is therefore transmitted by the client device, in order to restrict and optimize the subsequent measuring to the candidate beams, whereby also the subsequent beam measurement indication is optimized. The client device can thus, based on the beam measurement information, optimize its beam pair measurements thereby reducing such measurements, and can also optimize its subsequent beam pair indication, resulting in lower reporting overhead. The optimized beam pair measurement and indication therefore result in less latency associated with the beam management/alignment procedures compared to conventional solutions.

In an implementation form of a client device according to the first aspect, the beam measurement information indicates at least one transmit beam of the network access node that will be measured by the client device in the subsequent reference signal transmissions.

An advantage with this implementation form is that an optimized subsequent reference signal measurement of the at least one transmit beam can be performed based on the indicated beam measurement information, which results in less measurements, less reporting overhead, and reduced latency.

In an implementation form of a client device according to the first aspect, the beam measurement information indicates at least one receive beam of the client device that will be used by the client device for measurement in the subsequent reference signal transmissions.

An advantage with this implementation form is that a more targeted subsequent reference signal measurement can be performed based on the indicated beam measurement information, which results in less measurements, less reporting overhead, and reduced latency.

In an implementation form of a client device according to the first aspect, the beam measurement information indicates a number of measurements that will be performed by the client device for at least one transmit beam of the network access node in the subsequent reference signal transmissions.

An advantage with this implementation form is that the client device will provide the beam measurement information indicating the number of measurements that it will perform on these beams. Based on the provided beam measurement information, a more optimized subsequent reference signal measurement of the beams can be performed, which requires less measurements, less reporting overhead, and reduces latency.

In an implementation form of a client device according to the first aspect, the beam measurement information is given in a bitmap format.

An advantage with this implementation form is that the client device may report a bitmap representing the DL Tx/Rx beam pairs the client device is going to measure. This enables a reduction of the search space for the optimal beam pair associated with the subsequent reference signal measuring. Consequently, less complexity and latency can be achieved during optimal beam pair prediction based on the bitmap format beam measurement information. Additionally, subsequent beam pair indication can be performed with lower overhead.

In an implementation form of a client device according to the first aspect, the client device is configured to:
select a beam pair based on reference signal measurements, the beam pair comprising a transmit beam of the network access node and a receive beam of the client device; and
transmit an indicator to the network access node, the indicator indicating the selected beam pair.

An advantage with this implementation form is that, in the subsequent reference signal resources measurements, beam pair indication can be conveyed by the client device with reduced latency and overhead, which saves uplink control information resources.

In an implementation form of a client device according to the first aspect, the indicator is given by any one of:
a downlink reference signal indicator and an uplink reference signal indicator,
a downlink reference signal indicator and a repetition index indicator, and
an indicator indicating at least one non-zero entry in a beam measurement information bitmap.

An advantage with this implementation form is that the indication of a beam pair can be performed based on the information provided in the beam measurement information. Depending on the selected format, reduced overhead can be achieved in the subsequent reference signal measurements. Especially, if the client device indicates in the beam measurement information that a limited set of beam pair candidates is considered for the measurements.

In an implementation form of a client device according to the first aspect, the reference signal measurements are signal to noise and interference ratio measurements or received reference signal power measurements.

An advantage with this implementation form is that already supported beam measurement quantities in 5G NR are utilized for the reference signal measurements, which makes the implementation of the proposed solution more practical and straightforward.

In an implementation form of a client device according to the first aspect, the client device is configured to:
perform measurements on reference signals transmitted by the network access node in the subsequent reference signal transmissions based on the beam measurement information.

An advantage with this implementation form is that the client device may determine that not all beam pair candidates need to be measured. Consequently, the measurements can be targeted, whereby the number of measurements can be reduced, and also the subsequent beam indications can be performed with reduced overhead and latency.

In an implementation form of a client device according to the first aspect, the set of transmit beams of the network access node are a set of transmit beams used for a beam sweep procedure.

An advantage with this implementation form is that the client device can derive beam measurement information from measurements of reference signals in the set of transmit beams and can thereby indicate beam measurement information relevant to a first resource set associated with the set of transmit beams, or relevant to a second resource set associated with the candidate transmit beams, which may be included in the first resource set.

According to a second aspect of the application, the above mentioned and other objectives are achieved with a network access node, the network access node being configured to:
receive a beam measurement information of a client device for subsequent reference signal transmissions in a beam alignment procedure; and
transmit reference signals to the client device in at least one transmit beam in the subsequent reference signal transmissions based on the beam measurement information.

An advantage of the network access node according to the second aspect is that the subsequent reference signal measurements can be made more targeted and efficient based on the beam measurement information the client device has derived and transmitted to the network access node. Thus, the network access node receives beam measurement information indicating the measurement behavior the client device will adopt to during the subsequent beam pair measurements/sweeping. Based on this beam measurement information, the transmission of reference signals in transmit beams can be restricted and optimized, whereby the subsequent beam measurement indication is optimized. The hereby optimized beam pair measurement and indication therefore results in less latency and less reporting overhead associated with the beam management/alignment procedures, since less such measurements and reporting have to be performed.

In an implementation form of a network access node according to the second aspect, the beam measurement information indicates at least one transmit beam of the network access node that will be measured by the client device in the subsequent reference signal transmissions.

An advantage with this implementation form is that an optimized subsequent reference signal measurement of the at least one transmit beam can be performed based on the indicated beam measurement information, which results in less measurements, less reporting overhead, and reduced latency.

In an implementation form of a network access node according to the second aspect, the beam measurement information indicates at least one receive beam of the client device that will be used by the client device for measurement in the subsequent reference signal transmissions.

An advantage with this implementation form is that a more targeted subsequent reference signal measurement can be performed based on the indicated beam measurement information, which results in less measurements, less reporting overhead, and reduced latency.

In an implementation form of a network access node according to the second aspect, the beam measurement information indicates a number of measurements that will be performed by the client device for at least one transmit beam of the network access node in the subsequent reference signal transmissions.

An advantage with this implementation form is that the client device provides the beam measurement information indicating the number of measurements that it will perform on these beams. Based on the provided beam measurement information, a more optimized subsequent reference signal measurement of the beams can be performed, which requires less measurements, less reporting overhead, and reduces latency.

In an implementation form of a network access node according to the second aspect, the beam measurement information is given in a bitmap format.

An advantage with this implementation form is that the client device may report a bitmap representing the DL Tx/Rx beam pairs the client device is going to measure. This enables a reduction of the search space for the optimal beam pair associated with the subsequent reference signal measuring. Consequently, less complexity and latency can be achieved during optimal beam pair prediction based on the bitmap format beam measurement information. Additionally, subsequent beam pair indication can be performed with lower overhead.

In an implementation form of a network access node according to the second aspect, the network access node is configured to:
receive an indicator from the client device, the indicator indicating a beam pair comprising a transmit beam of the network access node and a receive beam of the client device; and
transmit reference signals to the client device in at least one transmit beam in the subsequent reference signal transmissions based on the beam measurement information and the indicator.

An advantage with this implementation form is that, in the subsequent reference signal resources measurements, beam pair indication can be conveyed by the client device with reduced latency and overhead, which saves uplink control information resources.

In an implementation form of a network access node according to the second aspect, the indicator is given by any one of:
a downlink reference signal indicator and an uplink reference signal indicator,
a downlink reference signal indicator and a repetition index indicator, and
an indicator indicating at least one non-zero entry in a beam measurement information bitmap.

An advantage with this implementation form is that the indication of a beam pair can be performed based on the information provided in the beam measurement information. Depending on the selected format, reduced overhead can be achieved in the subsequent reference signal measurements. Especially, if the client device indicates in the beam measurement information that a limited set of beam pair candidates is considered for the measurements.

According to a third aspect of the application, the above mentioned and other objectives are achieved with a method for a client device, the method comprises:
determining a set of candidate transmit beams of a network access node based on a set of measured reference signals transmitted in a set of transmit beams of the network access node in a beam alignment procedure;
determining a beam measurement information of the client device for subsequent reference signal transmissions based on the set of candidate transmit beams; and
transmitting the beam measurement information to the network access node.

The method according to the third aspect can be extended into implementation forms corresponding to the implementation forms of the client device according to the first aspect. Hence, an implementation form of the method comprises the feature(s) of the corresponding implementation form of the client device.

The advantages of the methods according to the third aspect are the same as those for the corresponding implementation forms of the client device according to the first aspect.

According to a fourth aspect of the application, the above mentioned and other objectives are achieved with a method for a network access node, the method comprises:
receiving a beam measurement information of a client device for subsequent reference signal transmissions in a beam alignment procedure; and
transmitting reference signals to the client device in at least one transmit beam in the subsequent reference signal transmissions based on the beam measurement information.

The method according to the fourth aspect can be extended into implementation forms corresponding to the implementation forms of the network access node according to the second aspect. Hence, an implementation form of the method comprises the feature(s) of the corresponding implementation form of the network access node.

The advantages of the methods according to the fourth aspect are the same as those for the corresponding implementation forms of the network access node according to the second aspect.

Embodiments of the application also relate to a computer program, characterized in program code, which when run by at least one processor causes the at least one processor to execute any method according to embodiments of the application. Further, embodiments of the application also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the application will be apparent from the following detailed description.

### BRIEF DESCRIPTION OF THE DRAWINGS

The appended drawings are intended to clarify and explain different embodiments of the application, in which:

FIG. 1 shows a client device according to an embodiment of the application;

FIG. 2 shows a flow chart of a method for a client device according to an embodiment of the application;

FIG. 3 shows a network access node according to an embodiment of the application;

FIG. 4 shows a flow chart of a method for a network access node according to an embodiment of the application;

FIG. 5 shows a communication system according to an embodiment of the application;

FIG. 6 shows a signaling diagram for DL Tx beam prediction according to embodiments of the application;

FIG. 7 shows an example of a bitmap and corresponding transmission resources and instances;

FIG. 8 shows a signaling diagram for DL Tx/Rx beam pair prediction according to embodiments of the application; and

FIG. 9 shows examples of DL Tx/Rx beam pair prediction.

### DETAILED DESCRIPTION

When an AI/ML model is used for DL Tx beam predictions during operation, i.e. after the AI/ML model has been trained, the network access node only transmits a sparse set of beams (which is called Set B in the 3GPP discussions) out of a full set of all possible beams (which is called Set A in the 3GPP discussions). The client device then only needs to measure and report the received power for the beams of the sparse set. Based on this information, the AI/ML model at the network side can predict the best suited beam, or beams, from the full set comprising all possible beams. Since the sparse set is smaller than the full set, overhead is saved compared to if the full set of all possible beams would be transmitted, measured and reported. According to an implementation, Set B may, instead of being a sparse set of beams, comprise a set of wide beams possibly being used during synchronization signal block (SSB) transmission.

Initially, the AI/ML model has to be trained during a training phase with a large amount of data, including e.g. transmitting all possible DL Tx beams (Set A) sequentially, measuring each of these DL Tx beams in a client device, and feedback these measurements to the network access node. After the training phase, the AI/ML model is able to learn the relationship between the feedback received for the beams of the sparse set, or alternatively for the set of wide SSB beams, and the beams of the full set.

Then, in a first operation phase (P1) after the training phase, the network access node sweeps over the beams of the sparse set, or alternatively of the set of wide SSB, i.e. transmits each of the beams of Set B. The client device measures the received power for each of the beams of the sparse set, or alternatively of the set of wide SSB, and reports the beam measurement quantities to the network access node, where they are used to determine a set of candidate transmit beams from the full, also called the top-K best beam candidates, set to be used.

In a second operation phase (P2), the beams of the set of candidate transmit beams are sequentially transmitted by the network access node. The client device measures each of the transmitted beams of the set of candidate transmit beams, and reports back the best beam out of this set of candidate transmit beams. This beam is then selected as the best DL Tx beam.

In a third operation phase (P3), the client device should identify the best suited DL Rx beam for reception of the best DL Tx beam selected in P2. The client device has multiple DL Rx beams available, but can only perform measurements with one DL Rx beam at a time, depending on its capabilities. Therefore, the network access node must repeatably transmit the best DL Tx beam selected in P2, such that it is possible for the client device to switch to, and perform measurements for, each one of its multiple available DL Rx beams. This repeated beam transmission and measuring for multiple available DL Rx beams causes latency and resource overhead in beam management. Also, since only one DL Tx beam, i.e. the selected best DL Tx beam, is repeatedly transmitted and measured, only a restricted number of DL Tx/Rx beam combinations are tested based on measurements, resulting in a risk for reduced accuracy.

As an alternative to the above presented second and third operation phases, all beams in the set of candidate transmit beams, i.e. all the top-K best candidate beams, can be sequentially transmitted by the network access node and be sequentially received and measured by all the multiple available DL Rx beams. This approach causes even more latency and resource overhead for the beam management.

As another alternative to the above presented second and third operation phases, all beams in the set of candidate transmit beams can be sequentially transmitted by the network access node and be sequentially received and measured by only one of the multiple available DL Rx beams. However, only a restricted number of DL Tx/Rx beam combinations are then tested, resulting in a risk for reduced accuracy.

Generally, a relatively large sized beam codebook may be used for the DL Tx and Rx beams. The number of possible DL Tx beams or DL Tx/Rx beam pairs to be used is therefore large, causing the resource overhead and latency. Also, these problems are further increased when the client device is capable of multi-panel transmission.

According to embodiments of the application, a client device is therefore enabled to provide additional beam measurement information associated with the set of candidate transmit beams, which may be used for reducing the latency and the resource overhead of the beam alignment procedure.

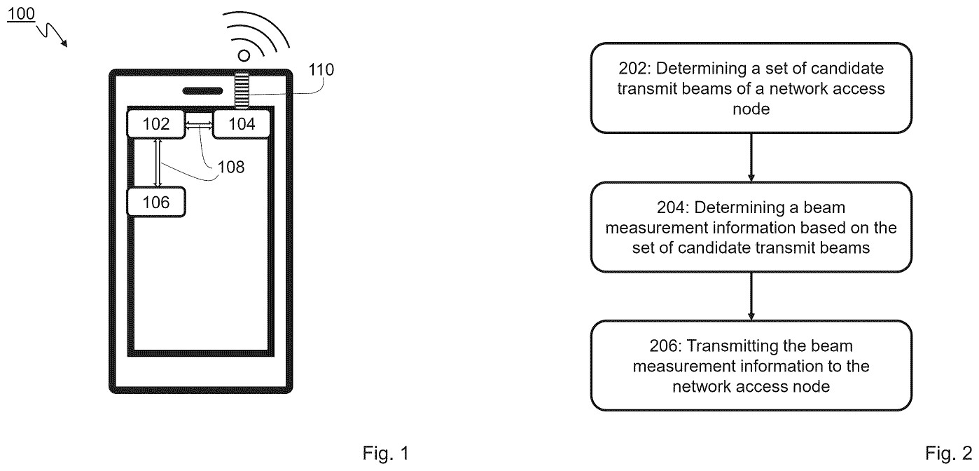

FIG. 1 shows a client device 100 according to an embodiment of the application. In the embodiment shown in FIG. 1, the client device 100 comprises a processor 102, a transceiver 104 and a memory 106. The processor 102 is coupled to the transceiver 104 and the memory 106 by communication means 108 known in the art. The client device 100 further comprises an antenna or antenna array 110 coupled to the transceiver 104, which means that the client device 100 is configured for wireless communications in a communication system.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices. The transceiver 104, memory 106 and/or processor 102 may be implemented in separate chipsets or may be implemented in a common chipset.

That the client device 100 is configured to perform certain actions can in this disclosure be understood to mean that the client device 100 comprises suitable means, such as e.g., the processor 102 and the transceiver 104, configured to perform the actions.

According to embodiments of the application the client device 100 is configured to determine a set of candidate transmit beams of a network access node 300 based on a set of measured reference signals transmitted in a set of transmit beams of the network access node 300 in a beam alignment procedure. The client device 100 is further configured to determine a beam measurement information of the client device 100 for subsequent reference signal transmissions based on the set of candidate transmit beams. The client device is further configured to transmit the beam measurement information 510 to the network access node 300.

Furthermore, in an embodiment of the application, the client device 100 for a communication system 500 comprises a processor configured to determine a set of candidate transmit beams of a network access node 300 based on a set of measured reference signals transmitted in a set of transmit beams of the network access node 300 in a beam alignment procedure. The processor is further configured to determine a beam measurement information of the client device 100 for subsequent reference signal transmissions based on the set of candidate transmit beams. The client device 100 also comprises a transceiver configured to transmit the beam measurement information 510 to the network access node 300.

Moreover, in yet another embodiment of the application, the client device 100 for a communication system 500 comprises a processor and a memory having computer readable instructions stored thereon which, when executed by the processor, cause the processor to: determine a set of candidate transmit beams of a network access node 300 based on a set of measured reference signals transmitted in a set of transmit beams of the network access node 300 in a beam alignment procedure; determine a beam measurement information of the client device 100 for subsequent reference signal transmissions based on the set of candidate transmit beams; and transmit the beam measurement information 510 to the network access node 300.

FIG. 2 shows a flow chart of a corresponding method 200 which may be executed in a client device 100, such as the one shown in FIG. 1. The method 200 comprises determining 202 a set of candidate transmit beams of a network access node 300 based on a set of measured reference signals transmitted in a set of transmit beams of the network access node 300 in a beam alignment procedure. The method 200 further comprises determining 204 a beam measurement information of the client device 100 for subsequent reference signal transmissions based on the set of candidate transmit beams. The method 200 further comprises transmitting 206 the beam measurement information 510 to the network access node 300.

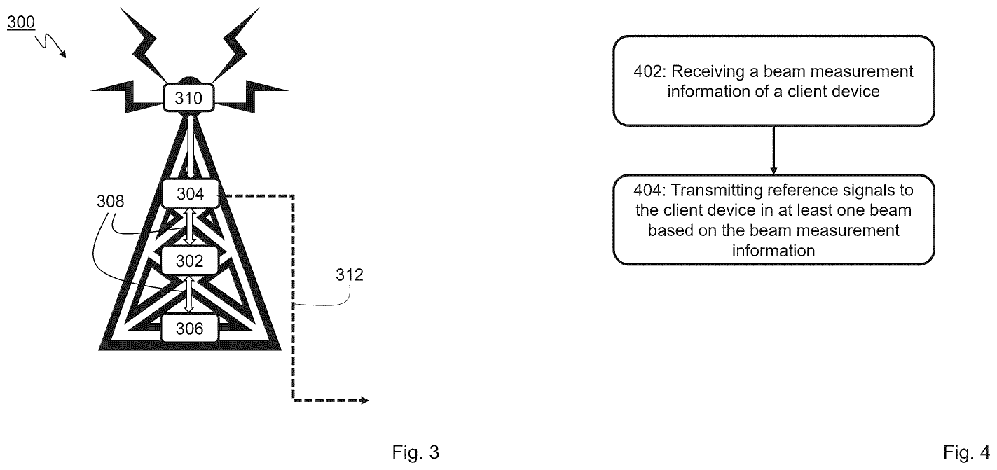

FIG. 3 shows a network access node 300 according to an embodiment of the application. In the embodiment shown in FIG. 3, the network access node 300 comprises a processor 302, a transceiver 304 and a memory 306. The processor 302 is coupled to the transceiver 304 and the memory 306 by communication means 308 known in the art. The network access node 300 may be configured for wireless and/or wired communications in a communication system. The wireless communication capability may be provided with an antenna or antenna array 310 coupled to the transceiver 304, while the wired communication capability may be provided with a wired communication interface 312 e.g., coupled to the transceiver 304.

The processor 302 may be referred to as one or more general-purpose CPU, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices, such as network nodes and network servers. The transceiver 304, the memory 306 and/or the processor 302 may be implemented in separate chipsets or may be implemented in a common chipset.

That the network access node 300 is configured to perform certain actions can in this disclosure be understood to mean that the network access node 300 comprises suitable means, such as e.g., the processor 302 and the transceiver 304, configured to perform the actions.

According to embodiments of the application, the network access node 300 is configured to receive a beam measurement information 510 of a client device 100 for subsequent reference signal transmissions in a beam alignment procedure. The network access node 300 is further configured to transmit reference signals to the client device 100 in at least one transmit beam in the subsequent reference signal transmissions based on the beam measurement information.

Furthermore, in an embodiment of the application, the network access node 300 for a communication system 500 comprises a transceiver configured to receive a beam measurement information 510 of a client device 100 for subsequent reference signal transmissions in a beam alignment procedure. The transceiver is further configured to transmit reference signals to the client device 100 in at least one transmit beam in the subsequent reference signal transmissions based on the beam measurement information.

Moreover, in yet another embodiment of the application, the network access node 300 for a communication system 500 comprises a processor and a memory having computer readable instructions stored thereon which, when executed by the processor, cause the processor to receive a beam measurement information 510 of a client device 100 for subsequent reference signal transmissions in a beam alignment procedure; and to transmit reference signals to the client device 100 in at least one transmit beam in the subsequent reference signal transmissions based on the beam measurement information.

FIG. 4 shows a flow chart of a corresponding method 400 which may be executed in a network access node 300, such as the one shown in FIG. 3. The method 400 comprises receiving 402 a beam measurement information 510 of a client device 100 for subsequent reference signal transmissions in a beam alignment procedure. The method further comprises transmitting 404 reference signals to the client device 100 in at least one transmit beam in the subsequent reference signal transmissions based on the beam measurement information.

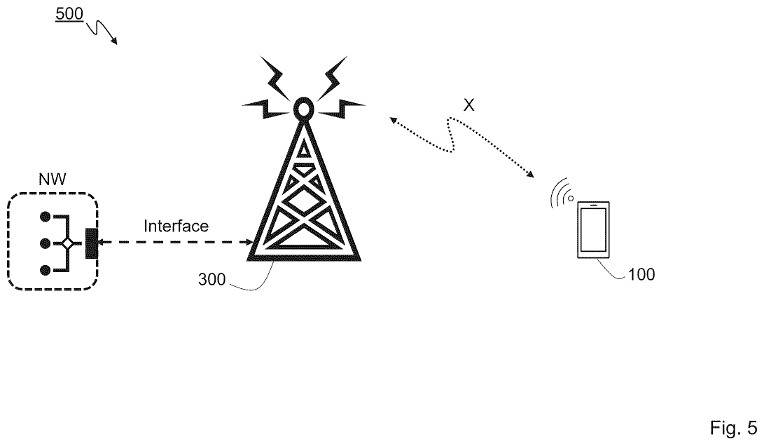

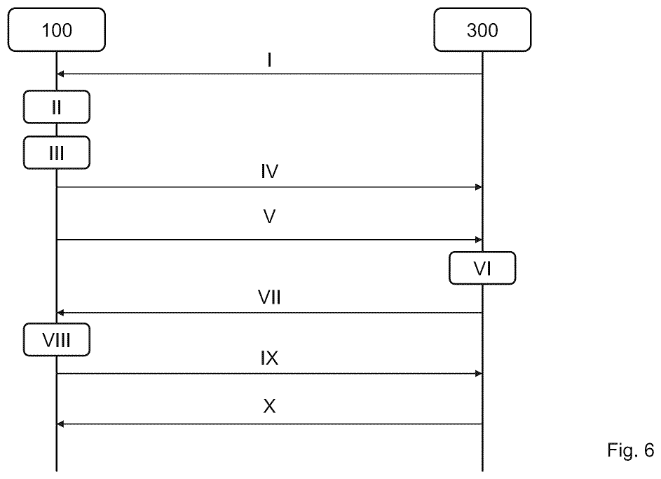

FIG. 5 shows a communication system 500 according to an embodiment of the application. The communication system 500 in the disclosed embodiment comprises a client device 100 and a network access node 300 configured to communicate and operate in the communication system 500. For simplicity, the shown communication system 500 only comprises one client device 100 and one network access node 300. However, the communication system 500 may comprise any number of client devices 100 and any number of network access nodes 300 without deviating from the scope of the application. The network access node 300 may be connected to a network NW such as e.g., a core network over a communication interface. The communication system 500 may be a communication system according to the 3GPP standard such as e.g., a 5G system in which case the client device 100 may be a UE and the network access node 300 may be a gNB but the application is not limited thereto.

Further details related to embodiments of the application will now be described at least partly in a 3GPP 5G context with reference to FIGS. 6 to 8. Thus, 3GPP 5G terminology, definitions, expressions and system architecture will sometimes be used. Especially, the client device 100 according to the application may in these embodiments be configured to perform any of the described functions of a 3GPP UE, and the access network node 300 according to the application may in these embodiments be configured to perform any of the described functions of a 3GPP gNB/TRP. It may however be noted that embodiments of the application are not limited thereto.

FIG. 6 shows a signaling diagram for the operation phase, i.e. the phase after a previous training phase, of the beam alignment procedure according to embodiments of the application utilizing DL Tx beam prediction.

In step I in FIG. 6, the network access node 300 transmits a set of reference signals in a set of transmit beams, e.g. corresponding to the above mentioned sparse set of DL Tx beams, or alternatively to the set of wide SSB beams. Thus, after the AI/ML model has been trained, the network access node 300 is configured to transmit a sparse set of DL Tx beams, or alternatively a set of wide SSB beams, i.e. is configured to transmit Set B out of a full set of all possible DL Tx beams (Set A). The client device 100 is configured with multiple DL Rx beams available for receiving the sparse set of DL Tx beams, or alternatively the set of wide SSB beams. According to an embodiment, the transmit beams of the network access node 300, i.e. the Set B beams, are a set of transmit beams used for a beam sweep procedure included in the beam alignment procedure.

In step II in FIG. 6, the client device 100 receives and measures the set of reference signals transmitted in the set of transmit beams and determines a set of candidate transmit beams of the network access node 300, e.g. corresponding to the above mentioned top-K best beam candidates, based on this set of measured reference signals. This determination of the set of candidate transmit beams is comprised in the beam alignment procedure. Thus, the client device 100 here performs measurements of the set of reference signals, and then determines, based on these measurements, the top-K DL Tx beams, i.e. the set of candidate transmit beams, in which the network access node thereafter should transmit reference signals according to the beam alignment procedure. According to embodiments, the reference signal measurements comprise e.g. signal to noise and interference ratio (SINR) measurements or received reference signal power (RSRP) measurements.

In step III in FIG. 6, the client device 100 determines a beam measurement information of the client device 100 to be used in connection with subsequent reference signal transmissions. This determination is based on the set of candidate transmit beams determined in step II. The beam measurement information may, according to embodiments, indicate how the client device 100 wants to perform measurements of the beams of the set of candidate transmit beams in the subsequent reference signal transmissions of the beam alignment process. Thus, in addition to determining the set of candidate transmit beams to be used by the network access node 300 for the subsequent reference signal transmissions (step II above), the client device 100 also determines how, and possibly also how often, it would like to perform the measurements of the subsequent reference signal transmissions of the set of candidate transmit beams. This information is comprised in the beam measurement information.

According to an embodiment, the beam measurement information indicates at least one transmit beam of the network access node 300, i.e. indicates at least one DL Tx beam, that will be measured, i.e. for which reference signals will be measured by the client device 100 in the subsequent reference signal transmissions.

According to an embodiment, the beam measurement information indicates at least one receive beam, i.e. at least one DL Rx beam, of the client device 100 that will be used by the client device 100 for measurement in the subsequent reference signal transmissions.

The aim of the beam measurement information is to convey to the network access node 300 information about the measurement behavior that the client device 100 will adopt to during the subsequent beam pair measurements/sweeping. The number of possible beam pairs can be quite excessive, especially for multi-panel and high capability client devices. The beam measurement information 510 is therefore transmitted by the client device 100 in order to restrict the necessary subsequent reference signal transmissions of the network access node 300, whereby less measurements and less reporting overhead is required.

According to an embodiment, the beam measurement information indicates a number of measurements that will be performed by the client device 100 for at least one transmit beam of the network access node 300, i.e. for at least one DL Tx beam in the subsequent reference signal transmissions. Thus, the number of measurements that will be performed per DL Tx beam is indicated. For example, the beam measurement information may indicate that the client device 100 wants to measure a DL Tx beam only once, wants to measure the DL Tx beam multiple times e.g. with different DL Rx beams, or wants to skip measurement of the DL Tx beam. For example, the beam measurement information may indicate which DL Rx beam that will be used at each measurement instance. This may be indicated as a mapping between at least one measurement instance or at least one DL reference signal (RS) repetition index, on one hand, and DL Rx beam IDs sounding reference signal (SRS) resource indicators (SRI) or UL/joint transmission configuration indicator (TCI) states, on the other hand. SRIs or UL/joint TCI states can be used in order to identify specific client device beams for Tx and/or Rx.

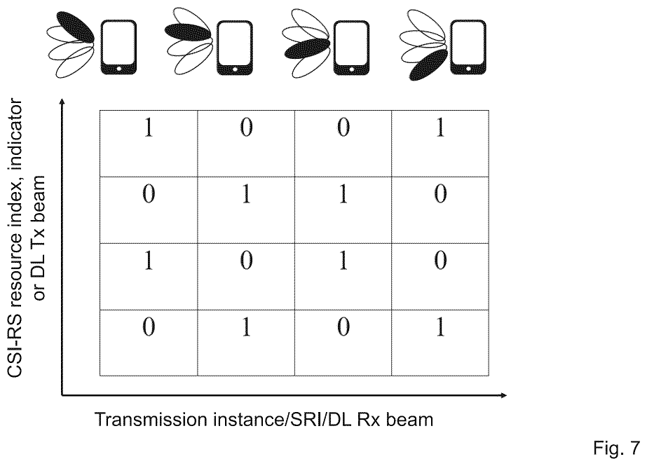

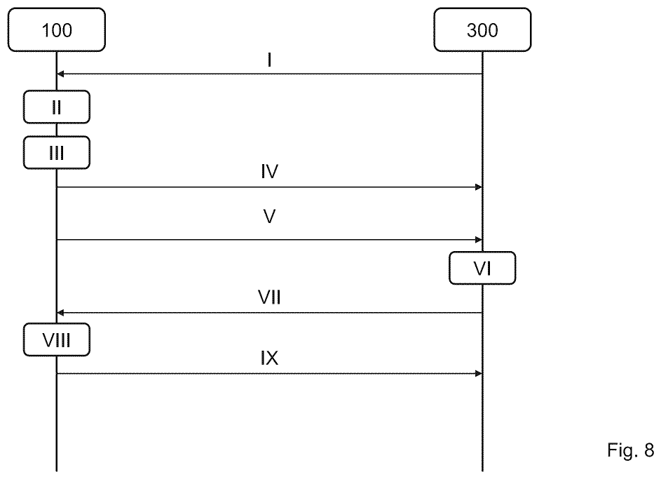

According to an embodiment, the beam measurement information is given in a bitmap format. For example, a bitmap of the beam measurement information may indicate whether a DL Rx beam is to be measured or not, during each one of a number of DL reference signal repetition instances. A bitmap of the beam measurement information may also indicate whether a DL Tx beam or DL RS resource is to be measured by the client device 100 or not, during a given transmission instance/repetition, such that the measured DL Tx/Rx beam pairs are reduced to a subset of the candidate DL beam pairs. The client device 100 may transmit this bitmap in a specific order, such that the following determination of e.g. the best DL beam pair is based on the beam measurement information in bitmap format, as is explained below. FIG. 7 shows a non-limiting example of such a bitmap, considering a set of 4 candidate transmit beams K=4, and a client device having 4 possible DL Rx beams. The columns of the bitmap shown in FIG. 7 indicate which DL Rx beams is used by the client device 100 for receiving and measuring DL Tx beams at different transmission instances of the reference signal transmissions, performed after the beam measurement information 510 has been transmitted to the network access node 300. The rows of the bitmap may indicate which DL Tx beams and/or the indices of the channel state information reference signal (CSI-RS) resources, that are measured in each transmission instance, e.g. may indicate a CSI-RS resource indicator (CRI). Thus, the bitmap may indicate whether a combination of DL Tx and Rx beam is measured or not during each one of possibly repeated transmission instances of the subsequent reference signal transmissions.

In step IV in FIG. 6, the client device 100 transmits information indicating the determined set of candidate transmit beams of the network access node 300, e.g. the top-K best beam candidates, to the network access node 300. Thus, the set of candidate transmit beams to be transmitted in subsequent reference signal transmissions in the beam alignment procedure are hereby indicated to the network access node 300.

In step V in FIG. 6, the client device 100 transmits the determined beam measurement information 510 to the network access node 300. Thus, in addition to indicating the set of candidate transmit beams to be used by the network access node 300 for the subsequent transmissions, the herein described beam measurement information 510 is transmitted to the network access node 300, which may indicate how, and possibly also how often, the client device 100 would like to measure the set of candidate transmit beams in the subsequent reference signal transmissions.

The beam measurement information 510 may be conveyed from the client device 100 to the network access node 300 in various way. According to an embodiment, the beam measurement information 510 may be dynamically signaled from the client device 100 to the network access device 300. For example, the beam measurement information 510 may be included together with other components of uplink control information (UCI) in a physical layer uplink control channel (PUCCH). Alternatively, the beam measurement information 510 may be signaled separately without other uplink control information in a PUCCH of its own. The beam measurement information 510 may also be multiplexed on a physical uplink shared channel (PUSCH) together with data transmission or other channel state information (CSI) reporting.

According to an embodiment, the beam measurement information 510, or at least parts of the measurement information, may be signaled by higher layers. For example, a set of beam measurement information features may be configured by radio resource control (RRC), e.g. in a table such that entries to the table may be indicated dynamically.

According to an embodiment, the transmission of the beam measurements information 510 may be triggered by the network in a downlink control information (DCI) received in the DL by the client device 100. It may be configured to be transmitted periodically or it may be transmitted on the initiative of the client device 100, without a prior trigger from the network. The latter reporting behavior may be referred to as event-triggered reporting. According to embodiments, the network may, in addition to the reporting configuration, dynamically activate or deactivate event-triggered reporting.

According to embodiments, periodic, aperiodic, or semi-persistent reporting are supported in the UCI over PUCCH/PUSCH, in a medium access control (MAC) control element (CE), or in a radio resource control (RRC) message.

According to an embodiment, the beam transmission information 510 may be configured as a reporting quantity in a CSI reporting configuration. It may be reported together with other quantities, such as channel state information reference signal indicator (CRI), synchronization signal block resource indicator (SSBRI), RSRP, or signal to interference and noise ratio SINR.

In step VI of FIG. 6, the network access node 300 receives the information indicating the determined set of candidate transmit beams of the network access node 300 and the beam measurement information 510. As mentioned above in connection with step III, the beam measurement information 510 may comprise information associated with the subsequent reference signal transmissions indicating at least one transmit beam of the network access node that will be measured by the client device 100, at least one receive beam of the client device 100 that will be used by the client device 100 and/or a number of measurements that will be performed by the client device 100 for at least one transmit beam of the network access node 300.

In step VII in FIG. 6, the subsequent reference signal transmissions are performed. The network access node 300 here transmits reference signals to the client device 100 in at least one transmit beam in the subsequent reference signal transmissions based on the beam measurement information. Thus, the subsequent reference signal transmissions of the beam alignment procedure, utilizing at least one beam of the indicated set of candidate transmit beams, are performed based on the received beam measurement information, i.e. are performed in line with the suggestions of the client device 100. Since the subsequent reference signal transmissions are based on the beam measurement information 510 provided by the client device 100, the beam alignment of the DL Tx beam and the DL Rx beam is provided with improved accuracy and reduced latency.

In step VIII in FIG. 6, the client device 100 determines the best transmit beam of the network access node 300, i.e. the best DL Tx beam, based on the subsequent reference signal transmissions of the beam alignment procedure.

In step IX in FIG. 6, the client device 100 transmits information indicating the best DL Tx beam to the network access node 300.

In step X in FIG. 6, the network access node 300 utilizes the indicated best DL Tx for subsequent transmissions of reference signals performed for identifying the best suited DL Rx beam.

According to embodiments of the application, the beam measurement information is used for beam alignment with DL Tx/Rx beam pair prediction. The client device 100 is then configured to select a beam pair based on reference signal measurements. The reference signal measurements may e.g. comprise SINR measurements or RSRP measurements. The selected beam pair comprises a transmit beam of the network access node 300, i.e. a DL Tx beam, and a receive beam of the client device 100, i.e. a DL Rx beam, that the client device 100 considers may constitute the best beam pair, i.e. the pair providing the best equivalent channel conditions for an ongoing communication. The client device 100 is further configured to transmit an indicator 520 to the network access node 300, where the indicator 520 indicates the selected beam pair. Thus, the transmitted indicator 520 informs the network access node 300 of which beam pair the client device 100 has selected as possibly being the best beam pair for subsequent transmissions. The client device 100 is further configured to perform measurements on reference signals transmitted by the network access node 300 in subsequent reference signal transmissions based on the beam measurement information and the indicator 520. These subsequent reference signal transmissions may result in a determination of that the selected beam pair is the optimal beam pair.

Correspondingly, the network access node 300 is configured to receive the indicator 520 from the client device 100. As mentioned above, this indicator 520 indicates a beam pair selected by the client device 100 as possibly being a best DL Tx/Rx beam pair. The network access node 300 is further configured to, based on the beam measurement information and the indicator 520, transmit reference signals to the client device 100 in at least one transmit beam, e.g. in the DL Tx of the selected beam pair, in the subsequent reference signal transmissions. Thus, the DL Tx of the selected beam pair will by the network access node 300 be used for further transmissions of reference signals, based on which it may be determined that the selected beam pair is the optimal beam pair.

The indicator 520 transmitted by the client device 100 and received by the network access node 300 may comprise a DL reference signal indicator and an UL reference signal indicator. The indicator 520 may also comprise a DL reference signal indicator and a DL reference signal repetition index indicator. The indicator 520 may further comprise an indicator indicating at least one non-zero entry in a beam measurement information bitmap, i.e. in a beam measurement information 510 of the above mentioned bitmap format. The beam measurement information 510 conveys to the network access node 300 with how many Rx beams a given Tx beam is measured, if any, and/or which DL Rx/Tx beam pairs that were measured by the client device 100.

FIG. 8 shows a signaling diagram for the operation phase of the beam alignment procedure using DL Tx/Rx beam pair prediction according to embodiments of the application.

In step I in FIG. 8, which corresponds to step I of FIG. 6, the network access node 300 transmits a set of transmit beams, e.g. corresponding to the above mentioned sparse set of DL Tx beams, or alternatively the set of wide SSB beams.

In step II in FIG. 8, the client device 100 receives the sparse set of DL Tx, or alternatively the set of wide SSB beams, measures each of the DL Tx beams with one or more of its DL Rx beams, and determines a set of candidate beam pairs/combinations, i.e. a set of candidate DL Tx/Rx beam pairs, also denoted top-K Tx/Rx beam pairs/combinations. The DL Tx beams of the top-K Tx/Rx beam pairs may be selected from all available DL Tx beams (Set A), and the DL Rx beams of the top-K Tx/Rx beam pairs may be selected from all available DL Rx beams, or from a restricted set of possible Rx beams, which is selected by the client device 100 or configured or indicated by the network. The determination of the set of candidate DL Tx/Rx beam pairs is based on a set of measured reference signals transmitted in the sparse set DL Tx beams, or alternatively in the set of wide SSB beams.

An issue in step II, i.e. for the inference measurement stage when the top-K Tx/Rx beam pairs are predicted, is that the same DL Tx beam might be part of multiple Tx/Rx beam pair combinations. Also, since radio conditions and/or the client device locations change over time, inference measurements need to be repeated periodically, and different inference measurement operations will in general result in different predictions for the top-K Tx/Rx beam pair combinations. The rate at which the top-K Tx/Rx beam pair combinations changes depends heavily on the velocity and mobility pattern of the client device 100. The network access node 300 and client device 100 should be able to adapt to these changes dynamically.

Further, it is according to conventional solutions, impossible for the network access node 300 to know with how many different DL Rx beams a certain DL Tx beam will become measured. Therefore, the network access node 300 has to assume the worst case for all DL Tx beams, meaning that it needs to repeat transmission of each DL Tx beam according to the maximum number of DL Rx beams that the client device 100 has available. This result in large overhead and latency. Also, to only repeat the best DL Tx beam during DL Rx beam measurements would result in a reduced reference signal overhead, but would also result in a very limited number of combinations being measured, and thus in reduced accuracy for the beam pair prediction.

It should further be noted that an approach of instead setting K=1 for the determination of the set of top-K candidate DL Tx/Rx beam pair candidates in step II, such that only one best DL Tx/Rx beam pair is directly suggested by the AI/ML model and indicated to the network access node 300 after step II, is expected to result in poor accuracy. In other words, the probability is very low that the AI/ML model directly predicts a single best DL Tx/Rx pair out of the set of all available combinations. Therefore, to increase the likelihood that the best DL Tx/Rx beam pair will be chosen in the end, the AI/ML model will suggest multiple candidate DL Tx/Rx beam pairs, i.e. top-K with K>1, that will be evaluated in the following steps.

In step III in FIG. 8, the client device 100 determines a beam measurement information of the client device 100 to be used in connection with subsequent reference signal transmissions. This determination is based on set of candidate DL Tx/Rx beam pairs determined in step II, including the set of candidate DL Tx beams. The beam measurement information may, according to various embodiments, indicate how the client device 100 wants to measure the set of candidate DL Tx/Rx beam pairs, and thus how it wants to measure the DL Tx beams of the set of candidate DL Tx/Rx beam pairs in the subsequent reference signal transmissions of the beam alignment process. Thus, in addition to determining the set of candidate DL Tx/Rx beam pairs to be used by the network access node 300 for the subsequent reference signal transmissions, the client device 100 also determines the beam measurement information.

In step IV in FIG. 8, the client device 100 transmits the indicator 520, indicating the determined set of candidate DL Tx/Rx beam pairs, e.g. the top-K best DL Tx/Rx beam pair candidates, to the network access node 300. Hereby, the set of candidate DL Tx/Rx beam pairs to be transmitted in subsequent reference signal transmissions in the beam alignment procedure is indicated to the network access node 300.

According to an embodiment, the client device 100 may transmit/report a CRI, together with a repetition index or SRI, when indicating the top-K best DL Tx/Rx beam pair candidates to the network access node 300. For example, the CRI may be indicated based on all repetitions of downlink reference signal (DL-RS) resources, such that the CRI indicates both a CSI-RS resource and a repetition index.

According to embodiments, the indication of the best DL Tx/Rx beam pair candidates spans ┌Log₂(K×Nᵣₑₚₑₜᵢₜᵢₒₙ)┐ or ┌Log₂ (K)┐+┌Log₂(Nᵣₑₚₑₜᵢₜᵢₒₙ)┐, where K refers to the number of transmitted DL Tx beams or RS resources per repetition, and Nᵣₑₚₑₜᵢₜᵢₒₙ refers to the number of repetition during downlink reference signal (DL-RS) transmission for beam measurements.

According to embodiments, the best DL Tx/Rx beam pair candidates spans

$$⌈ {Log}_{2} ( {\sum }_{k = 1}^{K} {N}_{k} ) ⌉ ,$$

wherein Nₖ is the number of repetitions, or measurements, or Rx beams considered for each DL Tx beam, for k=1 . . . K.

As mentioned above, CRI stands for CSI-RS resource indicator. The CSI-RS is sent from the network access node 300 to the client device 100. This indicator can be reported together with the RSRP values where the RSRP belongs to the CSI-RS resource. Thus, the network access node 300 then knows which power that is received for the CSI-RS resource, using a given Rx beam.

SRI stands for SRS resource indicator. The SRS is sent from the client device 100 to the network access node 300, and may be used by the network access node 300 to measure the UL channel. The network access node 300 can then measure different SRSs and determine the optimal antenna port for PUSCH. SRI can also be used for identifying a specific client device beam. Consequently, a combination of CRI and SRI can indicate Tx/Rx beam pairs.

In step V in FIG. 8, the client device 100 transmits the determined beam measurement information 510 to the network access node 300. Thus, in addition to transmitting the indicator 520, indicating the set of candidate DL Tx/Rx beam pairs to be used by the network access node 300 for the subsequent reference signal transmissions, the herein described beam measurement information is transmitted to the network access node 300.

In step VI in FIG. 8, the network access node 300 receives the indicator 520 indicating the determined set of candidate DL Tx/Rx beam pairs and the beam measurement information 510. As mentioned above, the beam measurement information 510 may comprise various information related to the subsequent reference signal transmissions.

In step VII in FIG. 8, the subsequent reference signal transmissions are performed. The network access node 300 here transmits reference signals to the client device 100 in at least one DL Tx/Rx beam pair in the subsequent reference signal transmissions based on the beam measurement information. Thus, the subsequent reference signal transmissions of the beam alignment procedure, utilizing at least one DL Tx/Rx beam pair indicated by the indicator 520, are performed based on the received beam measurement information, i.e. are performed in line with or according to the suggestions of the client device 100. Since the subsequent reference signal transmissions are based on the beam measurement information 510 provided by the client device 100, the beam alignment procedure is achieved with improved accuracy and reduced latency compared to conventional solutions.

In step VIII in FIG. 8, the client device 100 selects/determines the best DL Tx/Rx beam pair based on the subsequent reference signal transmissions of the beam alignment procedure.

In step IX in FIG. 8, the client device 100 transmits information indicating the selected best DL Tx/Rx beam pair to the network access node 300.

The above presented DL Tx beam prediction and DL Tx/Rx beam pair prediction, respectively, may be AI/ML model based, i.e. may be comprised in an AI/ML based beam alignment/management. In the embodiments illustrated by FIGS. 6 and 8 the AI/ML model used to predict a set of best suited top-K DL TX beams, or used to predict a set of beast suited top-K DL Tx/Rx beam pairs, is deployed at the client device 100 side. However, according to embodiments, the AI/ML model may be deployed at the client device 100 side, at the network access node 300 side, or at both the client device 100 side and the network access node 300 side.

A feature of the herein described embodiments, where the AI/ML model is deployed at the client device 100 side, at the network access node 300 side, or at both sides 100, 300, is that the network access node 300 receives the determined beam measurement information 510 from the client device 100, and uses this received beam measurement information 510 to optimize its DL Tx beam transmissions. Thus, after the client device 100 has measured the sparse set of beams based on CSI-RS, or alternatively the set of wide SSB beams, the AI/ML model determines which DL Tx beams or DL Tx/Rx beam pairs that are suitable to be included in a set of candidate transmit beams or beam pairs, respectively, i.e. which are likely to include the optimal final DL Tx beam or DL Tx/Rx beam pair, respectively. As explained above, the measurements and the determination of the beam measurement information 510 are comprised in step II of FIGS. 6 and 8, respectively.

These candidate sets of transmit beams, or beam pairs, are then evaluated, i.e. are transmitted and measured, in a second round beam sweep. This second round is comprised in steps VII and VIII of FIGS. 6 and 8, respectively. The evaluation of the second round beam sweep may or may not require repeated transmissions of certain DL Tx beams. Exactly, how many repetitions are needed for each of the candidate DL Tx beams will be known at the client 100 side after AI/ML inference processing, i.e. after steps II and III are performed in FIGS. 6 and 8, respectively. The client device 100 is, according to the herein described embodiments, configured to signal this information as the beam measurement information 510 to the network access node 300 in step V of FIGS. 6 and 8.

The signaled beam measurement information 510 may be conveyed in different formats, such as in a bitmap format, as mentioned above. The signaled beam measurement information 510 may comprise entries about one or more instances for when transmission of the set of candidate transmit beams, i.e. the top-K DL Tx beams, or the set of candidate beam pairs, i.e. the top-K Tx/Rx beam pairs, should take place. For example, based on the beam measurement information 510, the second round beam sweep may comprise CSI-RS measurements performed with different repetitions for different resources, or for different measurement patterns by the client device 100.

The signaled beam measurement information 510 hereby enables the client device 100 to measure all needed DL Tx beams, or DL Tx/Rx beam pairs, in the shortest possible time and to determine the optimal DL Tx beam, or DL Tx/Rx beam pair. The client device 100 may then in step IX of FIGS. 6 and 8, respectively, indicate to the network access node 300 a best DL Tx beam, or a best DL Tx/Rx beam pair, for example by transmitting a CRI and a repetition index or SRI, as explained above. The network access node 300 thereafter transmits with the indicated best DL Tx beam, or the best DL Tx/Rx beam pair.

In the use cases for the herein described embodiments, a relatively large sized beam codebook may be used. The number of possible DL Tx beams or DL Tx/Rx beam pairs, respectively, is thus large and are further increased when the client device 100 is capable of multi-panel transmission.

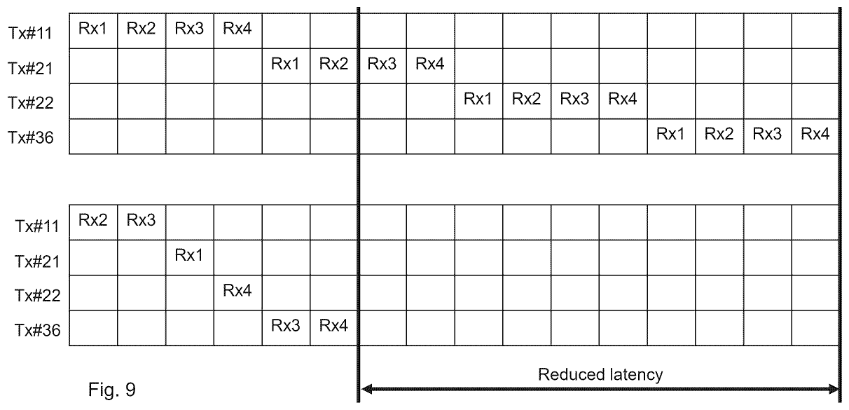

FIG. 9 schematically illustrates examples of subsequent reference signal transmissions for DL Tx/Rx beam pair prediction. It is in FIG. 9 assumed that a set of top-K DL Tx/Rx beam pairs are selected by the client device 100, e.g. by the AI/ML model of the client device 100. In this example, the set of top-K DL Tx/Rx beam pairs comprise the pairs of: {Tx#11/Rx2, Tx#11/Rx3, Tx#21/Rx1, Tx#22/Rx4, Tx#36/Rx3, Tx#36/Rx4}. The rows in FIG. 9 indicate the top-4 DL Tx beams, and the columns in FIG. 9 indicate transmission instances and the DL Rx beams being used for receiving DL Tx beams in these transmission instances, respectively.

In the reference signal transmission scheme, schematically illustrated in the top of FIG. 9, no beam measurement information 510 is determined by the client device 100, which means that the network access node 300 has no knowledge of any such information. Therefore, all combinations of the DL Tx beams and the DL Rx beams comprised in the selected set of top-K beam pairs is sequentially measured in repeated transmission instances, resulting in 16 transmission instances. Note that the repetitions of DL reference signal may be sparse in time.

In the reference signal transmission scheme schematically illustrated in the bottom of FIG. 9, the herein presented beam measurement information is determined by the client device 100 and is transmitted to the network access node 300. The network access node 300 is therefore enabled to adapt its DL Tx beam transmissions in the subsequent reference signal transmissions such that only the necessary combinations of the DL Tx beams and the DL Rx beams of the selected set of top-K beam pairs are measured. Hereby, an optimized DL Tx beam transmission pattern may be utilized for the subsequent reference signal transmissions, resulting in only 6 transmission instances in this example. Thus, a reduced latency associated with 10 transmission instances is here provided by herein presented embodiments utilizing the beam measurement information 510 for optimizing the DL beam pairs measurement pattern. Also, the reference signal transmission overhead is reduced by the much shorter DL Tx beam transmission pattern being optimized based on the beam measurement information.

According to herein described embodiments, the AI/ML model is used to predict a set of best suited top-K DL TX beams, or is used to predict a set of beast suited top-K DL Tx/Rx beam pair combinations. According to an example, a best suited beam is a beam which, when being used for transmission and/or reception, results into the largest/highest RSRP. Correspondingly, a best suited beam pair may be a beam pair which results in the largest transmission and/or reception RSRP. However, it is understood that also other criteria can be applied when the determining a best suited beam or beam pair, such as e.g. largest throughput, or largest layer 1 (L1) SINR.

As mentioned above, beam measurement information 510 is determined and provided to the network access node, wherein it is used to align the DL Tx and/or Rx transmission/reception patterns. This results in a more accurate DL Tx beam prediction and/or DL Tx/Rx beam pair prediction with low latency and low reference signal transmission overhead. Thus, the proposed solution also help to reduce latency when DL Tx beam prediction is performed by the AI/ML model, regardless of the AI/ML model is deployed at the network access node 300 side or at the client device 100 side.

The client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

The network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access nodes may be of different classes or types such as e.g., macro eNodeB, home eNodeB or pico base station, based on transmission power and thereby the cell size. The radio network access node may further be a station, which is any device that contains an IEEE 802.11-conformant MAC and PHY interface to the WM. The radio network access node may be configured for communication in 3GPP related LTE, LTE-advanced, 5G wireless systems, such as NR and their evolutions, as well as in IEEE related Wi-Fi, WiMAX and their evolutions.

Furthermore, any method according to embodiments of the application may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the client device and the network access node comprise the necessary communication capabilities in the form of e.g., functions, means, units, elements, etc., for performing or implementing embodiments of the application. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the client device and the network access node may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the application is not limited to the embodiments described above, but also relates to and incorporates all embodiments within the scope of the appended independent claims.

What is claimed is:

1. A client device (100), comprising:
a processor (102) and transceiver (106) wherein the processor (102) is configured to cause the client device (100) to:
determine a set of candidate transmit beams of a network access node (300) based on a set of measured reference signals transmitted in a set of transmit beams of the network access node (300);
determine a beam measurement information of the client device (100) for subsequent reference signal transmissions based on the set of candidate transmit beams; and the transceiver (106) is configured to transmit the beam measurement information (510) to the network access node (300).

2. The client device (100) according to claim 1, wherein the beam measurement information indicates at least one transmit beam of the network access node (300) that will be measured by the client device (100) in the subsequent reference signal transmissions.

3. The client device (100) according to claim 1, wherein the beam measurement information indicates at least one receive beam of the client device (100) that will be used by the client device (100) for measurement in the subsequent reference signal transmissions.

4. The client device (100) according to claim 1, wherein the beam measurement information indicates a number of measurements that will be performed by the client device (100) for at least one transmit beam of the network access node (300) in the subsequent reference signal transmissions.

5. The client device (100) according to claim 1, wherein the beam measurement information is given in a bitmap format.

6. The client device (100) according to claim 1, configured to:
select a beam pair based on reference signal measurements, the beam pair comprising a transmit beam of the network access node (300) and a receive beam of the client device (100); and
transmit an indicator (520) to the network access node (300), the indicator (520) indicating the selected beam pair.

7. The client device (100) according to claim 6, wherein the indicator is given by any one of:
a downlink reference signal indicator and an uplink reference signal indicator,
a downlink reference signal indicator and a repetition index indicator, and
an indicator indicating at least one non-zero entry in a beam measurement information bitmap.

8. The client device (100) according to claim 6, wherein the reference signal measurements are signal to noise and interference ratio measurements or received reference signal power measurements.

9. The client device (100) according to claim 1, configured to:
perform measurements on reference signals transmitted by the network access node (300) in the subsequent reference signal transmissions based on the beam measurement information.

10. The client device (100) according to claim 1, wherein the set of transmit beams of the network access node (300) are a set of transmit beams used for a beam sweep procedure.

11. A network access node (300), comprising:
Processor (302) and transceiver (306) wherein the processor (302) is configured to cause the network access node (300) to:
determine a beam measurement information of the client device (100) for subsequent reference signal transmissions based on the set of candidate transmit beams; and the transceiver (306) is configured to
receive a beam measurement information (510) of a client device (100) for subsequent reference signal transmissions; and
transmit reference signals to the client device (100) in at least one transmit beam in the subsequent reference signal transmissions based on the beam measurement information.

12. The network access node (300) according to claim 11, wherein the beam measurement information indicates at least one transmit beam of the network access node (300) that will be measured by the client device (100) in the subsequent reference signal transmissions.

13. The network access node (300) according to claim 11, wherein the beam measurement information indicates at least one receive beam of the client device (100) that will be used by the client device (100) for measurement in the subsequent reference signal transmissions.

14. The network access node (300) according to claim 11, wherein the beam measurement information indicates a number of measurements that will be performed by the client device (100) for at least one transmit beam of the network access node (300) in the subsequent reference signal transmissions.

15. The network access node (300) according to claim 11, wherein the beam measurement information is given in a bitmap format.

16. The network access node (300) according to claim 11, configured to:
receive an indicator (520) from the client device (100), the indicator (520) indicating a beam pair comprising a transmit beam of the network access node (300) and a receive beam of the client device (100); and
transmit reference signals to the client device (100) in at least one transmit beam in the subsequent reference signal transmissions based on the beam measurement information and the indicator.

17. The network access node (300) according to claim 16, wherein the indicator is given by any one of:
a downlink reference signal indicator and an uplink reference signal indicator, a downlink reference signal indicator and a repetition index indicator, and an indicator indicating at least one non-zero entry in a beam measurement information bitmap.

18. A method (200) for a client device (100), the method (200) comprises:
determining (202) a set of candidate transmit beams of a network access node (300) based on a set of measured reference signals transmitted in a set of transmit beams of the network access node (300) in a beam alignment procedure;
determining (204) a beam measurement information of the client device (100) for subsequent reference signal transmissions based on the set of candidate transmit beams; and
transmitting (206) the beam measurement information (510) to the network access node (300).
